(19) United States
(12) Patent Application Publication
(10) Pub. No.: US 2019/0187340 A1
(43) Pub. Date: Jun. 20, 2019

(54) LENS ASSEMBLY MODULE WITH LIGHT SHIELDING FILM

(71) Applicant: Spring Rainbow Optics Co., LTD, Taoyuan City (TW)

(72) Inventors: Yu-Teng Jheng, Changhua County (TW); Po-Liang Chiang, Taipei City (TW); Ming-Chun Chen, Taichung City (TW); Yung-Lieh Chang, Changhua County (TW); Hung-Chang Cho, Taichung City (TW); Pei-Min Chen, Taichung City (TW); Hsieh-Chang Liu, Taichung City (TW)

(21) Appl. No.: 16/222,371

(22) Filed: Dec. 17, 2018

Related U.S. Application Data
(60) Provisional application No. 62/608,001, filed on Dec. 20, 2017.

(51) Int. Cl. G02B 5/00; G02B 7/02

(52) U.S. Cl. CPC G02B 5/003; G02B 7/02

(57) ABSTRACT

A lens assembly module is provided and includes: a plurality of lenses, a lens barrel disposed around the lens and including an incident end, where light from the object enters the lens barrel, and an emergent end, where light from the object exits the lens barrel; and a first light shielding film disposed in a mounting recess, which is defined by a surface of one of the lenses closest to the emergent end and is adjacent to a circumference of the lens closest to the emergent end.

### CROSS REFERENCE TO RELATED APPLICATIONS

The present application claims the benefit of priority under 35 USC 119(e) of U.S. Provisional Patent Application No. 62/608,001 entitled “Lens Module with Light Shielding Member” and filed on Dec. 20, 2017, the contents of which are incorporated herein by reference in their entirety.

### FIELD OF INVENTION

The present disclosure relates to the technical field of a lens assembly module, and particularly to a lens assembly module, which includes a light shielding film to replace a back cover.

### BACKGROUND OF DISCLOSURE

Typically, a back cover is required for a general lens assembly module for achieving the function of waterproof sealing and the function of reducing stray light. As shown in FIG. 1, a conventional lens assembly module 1 has a lens 11, a barrel 12, a back cover 13, a light shielding film 14, and a spacer ring 15. The lens assembly module 1 can be combined with a sensor 3 to form a camera module. The design of the back cover 13 in the conventional lens assembly module 1 is described below.

As shown in FIG. 2, one of the main functions of the back cover 13 is waterproof sealing. Since the lens assembly module 1 is sensitive to moisture and dust, both the front end and the back end have to be sealed to prevent moisture and dust particles from entering the barrel 12.

For example, in the manufacturing processes, in order to improve the problem that dust remains on the surface of the lens assembly module 1, the lens assembly module 1 undergoes a washing process. However, the lens 11 in the lens assembly module is generally manufactured by injection molding, so an depression 111 is formed on the lens 11 on the position of the running gate during the shearing process (the outer circumference of the lens 11 is not a full circle). An slit 112 is formed when the lens 11 is assembled into the lens barrel 12. After the lens assembly module 1 undergoes the washing process, water flows into the lens assembly module 1 through the slit 112 and leaves residues, thereby causing a water stain issue. Therefore, in the general lens assembly module 1, a back cover 13 is assembled onto the lens closest to the sensor to achieve the sealing by a dispensing and curing process, or by a hot melt process.

The light reflected by the portion other than the aspherical optical effective area of the lens closest to the rearmost end (closest to the sensor) and the surface of the sensor 3 often causes stray light. In general, if the back cover 13 is absent in the lens assembly module 1, the stray light is easily reflected onto the sensor multiple times and influences the image. In order to reduce stray light, the aforementioned back cover 13 is generally made black or inked to absorb stray light.

However, at present, material of the back cover 13 is generally plastic. Although material is black in appearance, its effective reflectivity still causes considerable energy reflection. If stray light occurs, it may still cause a relatively significant and serious impact.

Furthermore, the back cover 13 has heavy weight, large size, and high costs, which are unfavorable to the manufacture of the lens assembly module 1. For example, the plastic back cover 13 has expensive molding costs. Even if the back cover 13 is made of metal, the back cover also has an expensive material cost issue.

An innovative design is needed for the lens assembly module to reduce the manufacture costs. Therefore, it is necessary to develop a\ novel member in a lens assembly module to replace the back cover 13.

### SUMMARY OF INVENTION

A primary object of the present disclosure is to provide a lens assembly module with a novel light shielding film to replace a back cover, for reducing the manufacture costs.

A lens assembly module is provided in an embodiment of the present disclosure, and includes:

a plurality of lenses configured for forming an optical image of an object,

a lens barrel disposed around the lens for supporting the lenses, and including an incident end, where light from the object enters the lens barrel, and an emergent end, where light from the object exits the lens barrel; and

a first light shielding film configured for shielding stray light, and disposed in a mounting recess, which is defined by a surface of one of the lenses closest to the emergent end and is adjacent to a circumference of the lens closest to the emergent end, wherein the first light shielding film and the mounting recess are both annular.

In accordance with an embodiment of the present disclosure, a depression is defined by a circumferential surface of the lens closest to the emergent end, a surface of the depression and the inner circumferential surface of the lens barrel together define an opening, and the first light shielding film is configured to completely cover the opening.

In accordance with an embodiment of the present disclosure, a plurality of indents are defined by an outer circumferential surface of the first light shielding film, and surfaces of the indents and an inner circumferential surface of the lens barrel together define a plurality of holes.

In accordance with an embodiment of the present disclosure, the first light shielding film includes an intact arc part ranging from 50° to 90°, wherein no indent is defined by the intact arc part, and the intact arc part is configured for completely covering the opening.

In accordance with an embodiment of the present disclosure, the first light shielding film is bonded to the lens closest to the emergent end and the lens barrel by an adhesive through the holes.

In accordance with an embodiment of the present disclosure, an outer radius of the first light shielding film is shorter than or equivalent to a radius of the lens closest to the emergent end.

In accordance with an embodiment of the present disclosure, material of the first light shielding film includes black polyethylene terephthalate (PE).

In accordance with an embodiment of the present disclosure, an angle between a side wall and a bottom of the mounting recess ranges from 93° to 130°, and a depth of the mounting recess is deeper than 0.01 mm.

In accordance with an embodiment of the present disclosure, a sub-recess is defined by a bottom of the mounting recess for storing the adhesive, and is adjacent to the circumference of the lens closest to the emergent end.

In accordance with an embodiment of the present disclosure, the lens assembly module further includes a second light shielding film configured for shielding stray light, and disposed between two of the lenses, wherein the second light shielding film is annular.

A lens assembly module is also provided in an embodiment of the present disclosure, and includes:

a lens barrel including:

a front end being close to an object side of the lens assembly module;

a rear end being close to an image side of the lens assembly module and being opposite to the front end; and

a peripheral wall which extends along an axis from the front end to the rear end and surrounds the axis to define a receiving chamber;

a plurality of lenses disposed in the receiving chamber in sequence along the axis between the front end and the rear end of the lens barrel, wherein an annular mounting recess is defined by a surface of the lens closest to the rear end and is adjacent to the peripheral wall of the lens barrel, and

a first light shielding film disposed in the mounting recess, wherein the first light shielding film and the mounting recess are both annular and coaxial with and the lens barrel.

In accordance with an embodiment of the present disclosure, a depression is defined by a lateral side of the lens closest to the emergent end, the depression and the peripheral wall of the lens barrel together define an opening, and the first light shielding film is configured to completely cover the opening.

In accordance with an embodiment of the present disclosure, a plurality of indents are defined by a lateral side of the first light shielding film, and the indents and the peripheral wall of the lens barrel together define a plurality of holes.

In accordance with an embodiment of the present disclosure, the first light shielding film includes an intact arc part ranging from 50° to 90°, wherein no indent is defined by the intact arc part, and the intact arc part is configured for completely covering the opening.

In accordance with an embodiment of the present disclosure, the first light shielding film is bonded to the lens closest to the rear and the lens barrel by an adhesive through the holes.

In accordance with an embodiment of the present disclosure, an outer radius of the first light shielding film is shorter than or equivalent to a radius of the lens closest to the rear end.

In accordance with an embodiment of the present disclosure, material of the first light shielding film includes black polyethylene terephthalate (PE).

In accordance with an embodiment of the present disclosure, an angle between a side wall and a bottom of the mounting recess ranges from 93° to 130°, and a depth of the mounting recess is deeper than 0.01 mm.

In accordance with an embodiment of the present disclosure, a sub-recess is defined by a bottom of the mounting recess for storing the adhesive, and is adjacent to the peripheral wall of the lens barrel.

In accordance with an embodiment of the present disclosure, the lens assembly module further includes a second light shielding film configured for shielding stray light, and disposed between two of the lenses, wherein the second light shielding film is annular and coaxial with the lens barrel.

In the lens assembly module in accordance with an embodiment of the present disclosure, the first light shielding film is disposed in the mounting recess defined by the surface of the lens closest to the rear end to replace the back cover for reducing the manufacture costs of the lens assembly module. The indents defined by the outer circumference of the first light shielding film, together with the peripheral wall of the lens barrel, defines a plurality of holes, through which the first light shielding film is bonded to the lens closest to the rear and the lens barrel by an adhesive. A depression defined by the circumference of the lens closest to the rear end is completely covered by the intact arc part of the first light shielding film for achieving the waterproof sealing effect. Material of the first light shielding film includes black polyethylene terephthalate (PE) having a low reflectivity and fulfilling the function of reducing stray light.

### BRIEF DESCRIPTION OF DRAWINGS

The foregoing aspects and many of the attendant advantages of this disclosure will become more readily appreciated as the same becomes better understood by reference to the following detailed description, when taken in conjunction with the accompanying drawings, wherein:

FIG. 1 is a cross-sectional side view illustrating a conventional lens assembly module.

FIG. 2 includes cross-sectional side views and top views illustrating a conventional lens assembly module before and after a back cover is assembled into the lens assembly module.

FIG. 3 is a cross-sectional side view illustrating a lens assembly module in accordance with an embodiment of the present disclosure.

FIG. 4 includes a cross-sectional side view and a top view illustrating an outer radius of a first light shielding film, R2, and a radius of a lens, R1 of a lens assembly module in accordance with an embodiment of the present disclosure.

FIG. 5 is a cross-sectional side view illustrating a mounting recess defined by a surface of a lens in a lens assembly module in accordance with an embodiment of the present disclosure.

FIG. 6 includes a cross-sectional side view and a top view illustrating a plurality of indents defined by an outer circumferential surface of a first light shielding film in a lens assembly module in accordance with an embodiment of the present disclosure.

FIG. 7 includes a cross-sectional side view and a top view illustrating an intact arc part ranging from 50° to 90° in a lens assembly module for completely covering an opening in accordance with an embodiment of the present disclosure.

FIG. 8 includes top views illustrating various first light shielding films in accordance with multiple embodiments of the present disclosure.

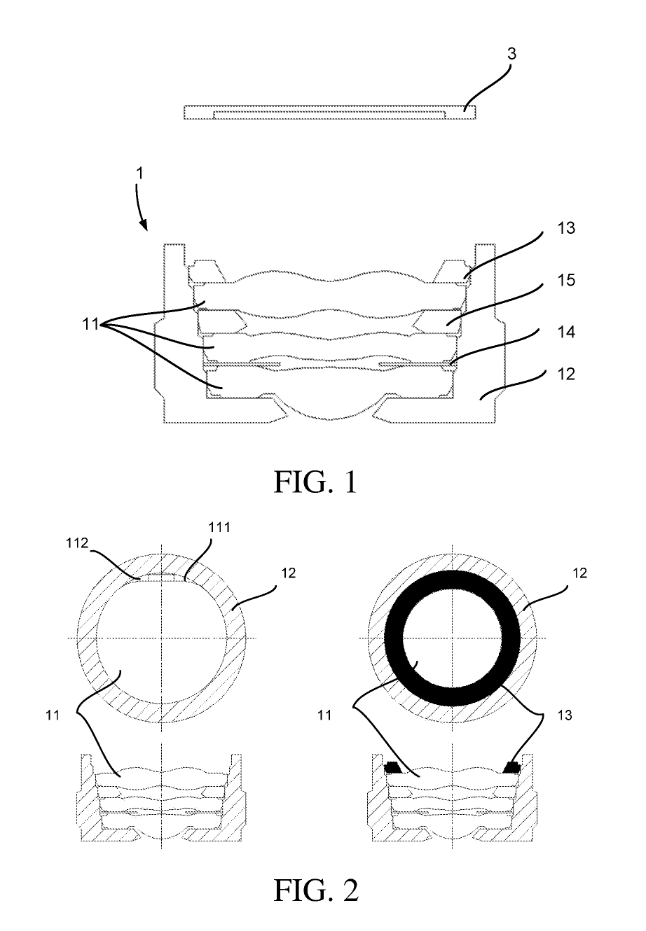

### DETAILED DESCRIPTION OF PREFERRED EMBODIMENTS

The following description of the embodiments with reference to the accompanying drawings is used to illustrate particular embodiments of the present disclosure. The directional terms used in the present disclosure, such as “upper”, “lower”, “front”, “back”, “left”, “right”, “inner”, “outer”, “side surface”, etc., are only directions with regard to the accompanying drawings. Therefore, the directional terms used for describing and illustrating the present disclosure are not intended to limit the present disclosure.

In the drawings, units with similar structures are indicated by the same reference number.

As to an “embodiment” mentioned herein, the particular features, structures, or characteristics described in this embodiment, which may be described in combination with the embodiment, may be included in at least one embodiment of the present disclosure. The phrases appearing at various locations in the specification do not necessarily refer to the same embodiments, nor to the embodiments being alternative to, mutually exclusive with, or independent from other embodiments. It is explicitly and implicitly understood by a person of ordinary skill in the art that the embodiments described herein may be combined with other embodiments.

The content of the present disclosure is described in detail by reference to embodiments below in conjunction with the accompanying drawings.

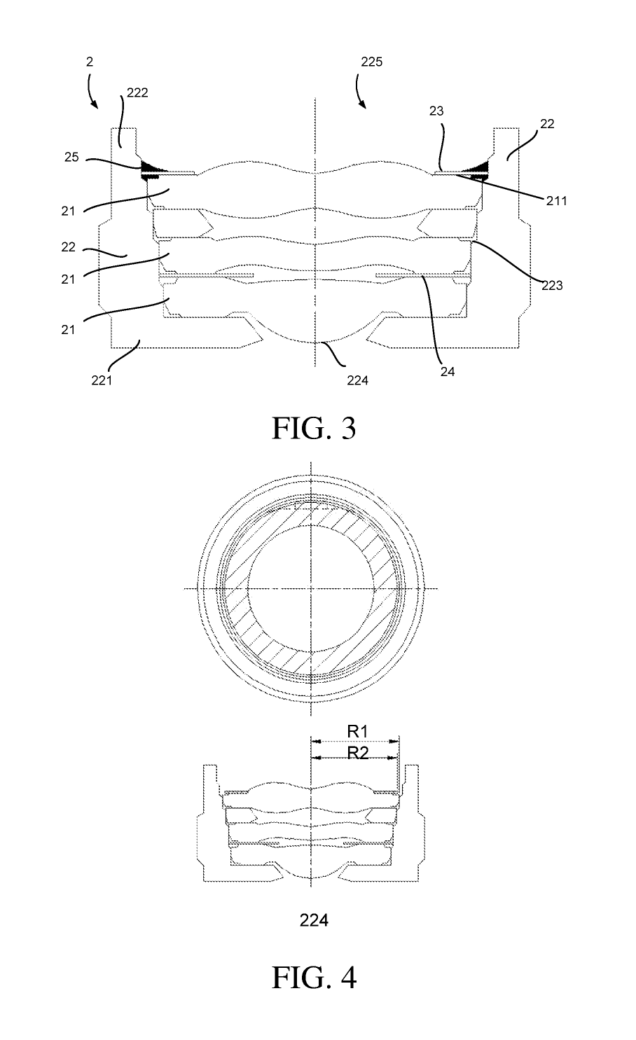

Refer to FIG. 3, which is a cross-sectional side view illustrating a lens assembly module in accordance with an embodiment of the present disclosure.

In the present disclosure, a lens assembly module 2 is provided and includes a plurality of lenses 21, a lens barrel 22, and a first light shielding film 23.

The lens barrel 22 is disposed around the lenses 21 for supporting the lenses 21, and includes a front end 221, a rear end 222, and a peripheral wall 223.

The front end 221 is close to an object side of the lens assembly module 2, and thus, generally, light from the object enters the lens barrel 22 through the front end 221, which may be referred to as an incident end in most embodiments. The rear end 222 is close to an image side of the lens assembly module 2 and opposite to the front end 221, and thus, generally, light from the object exits the lens barrel 22 through the rear end 221, which may be referred to as an emergent end in most embodiments. The peripheral wall 223 which extends along an axis 224 from the front end 221 to the rear end 222 and surrounds the axis 224 to define a receiving chamber 225.

The plurality of lenses 21 are configured for forming an optical image of the object, and are disposed in the receiving chamber 225 in sequence along the axis 224 between the front end 221 and the rear end 222 of the lens barrel 22, wherein a mounting recess 211 is defined by a surface of one of the lenses 21 closest to the rear end 222, and is configured for guiding, fixing and mounting the first light shielding film 23, and for making the first light shielding film 23 and the barrel 22 be coaxial. Generally, the mounting recess 211 and the first light shielding film 23 are both annular and are coaxial with the lens barrel 22. Typically, the mounting recess 211 is adjacent to a circumference of the lens 21 closest to the rear end 222, and, preferably, is adjacent to the peripheral wall 223 of the lens barrel 22.

The first light shielding film 23 is configured for shielding stray light, and is disposed in the mounting recess 211. In an embodiment of the present disclosure, black polyethylene terephthalate (PET) having a low reflectivity is used as material of the first light shielding film 23 to replace the back cover in the conventional lens assembly module and improve the function of reducing stray light. The surface of the first light shielding film 23 made of this material may undergo a blackening process. The unit price of the first light shielding film 23 is low, and no expensive plastic mold is needed.

Furthermore, in an embodiment of the present disclosure, in dispensing and curing processes, the lens barrel 22, the lenses 21 and the first light shielding film 23 are bonded together by dispensing an adhesive 25 (e.g. glue), and the assembled structure also achieves the same fixing and sealing effects as those of the back cover. Material of the adhesive 25 may also include black polyethylene terephthalate (PET).

Refer to FIG. 4, which includes a cross-sectional side view and a top view illustrating an outer radius of a first light shielding film, R2, and a radius of a lens, R1, of a lens assembly module in accordance with an embodiment of the present disclosure.

As shown in FIG. 3 and FIG. 4, in an embodiment of the present disclosure, for ensuring that the adhesive 25 (e.g. glue) smoothly flows from the top of the first light shielding film 23 to the lens 21 closest to the rear end 222 in the dispensing process, the outer radius of the first light shielding film 23 is shorter than or equivalent to the radius of the lens 21 closest to the rear end 222 (the outer radius of the first light shielding film 23 is R2, and the radius of the lens 21 is R1), and is longer than or equivalent to the radius of the lens 21 closest to the rear end 222 minus 0.05 mm. Specifically, the mathematical relationship is as follows: R1≥R2≥R1−0.05 mm.

Refer to FIG. 5, which a cross-sectional side view illustrating a mounting recess defined by a surface of a lens in a lens assembly module in accordance with an embodiment of the present disclosure.

As shown in FIG. 5, in an embodiment of the present disclosure, the mounting recess 211 is defined by a surface of the lens 21 closest to the rear end 222, is adjacent to the peripheral wall 223 of the lens barrel 22, and is configured for guiding, fixing or mounting the first light shielding film 23, and for making the first light shielding film 23 and the barrel 22 be coaxial, so that the width of the gap (R1−R2) between the first light shielding film 23 and the peripheral wall 223 of the barrel 22 is consistent.

In an embodiment of the present disclosure, an angle 2111 between a side wall 2112 and a bottom 2113 of the mounting recess 211 ranges from 93° to 130°, and a depth L of the mounting recess 211 is deeper than 0.01 mm. A sub-recess 212 is defined by the bottom 2113 of the mounting recess 211 for storing the dispensed adhesive 25 (e.g. glue), typically, is adjacent to the circumference of the lens 21 closest to the rear end 222 and, in some embodiments, is adjacent to the peripheral wall 223 of the lens barrel 22.

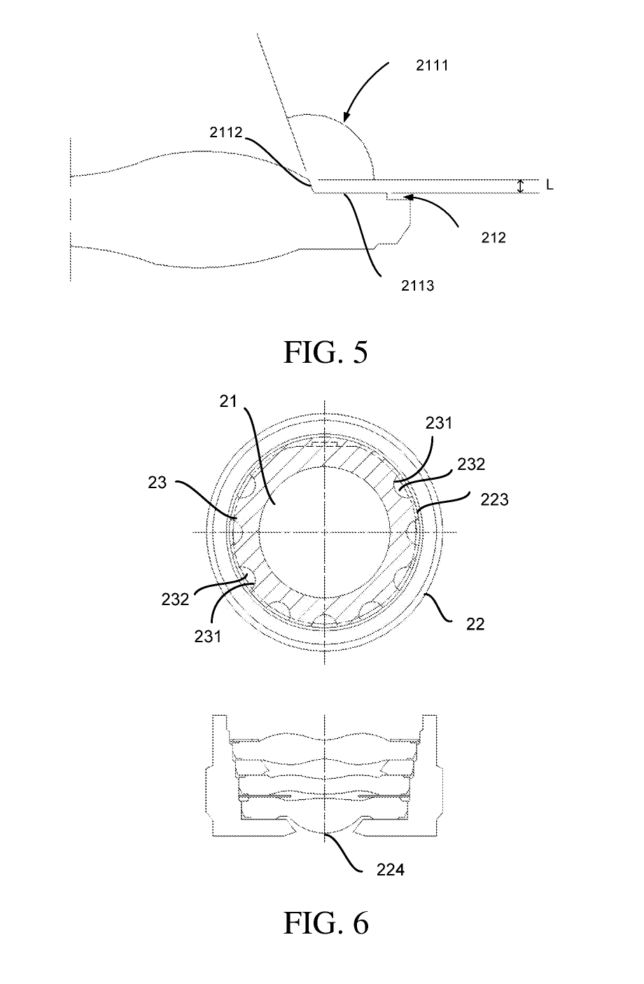

Refer to FIG. 6, which includes a cross-sectional side view and a top view illustrating a plurality of indents defined by an outer circumferential surface of a first light shielding film in a lens assembly module in accordance with an embodiment of the present disclosure.

In an embodiment of the present disclosure, the first light shielding film 23 is bonded to the lens 21 closest to the rear end 222 and the lens barrel 22 by the adhesive 25 (e.g. glue). In order to allow the glue 25 to smoothly and controllably pass to the lens 21, a plurality of indents 231 are defined by a lateral side of the first light shielding film 23, and the indents 231 and the peripheral wall 223 of the lens barrel 22 together define a plurality of holes 232, as shown FIG. 6. The glue 25 smoothly and controllably passes to the lens 21 through the holes 232. Specifically, the plurality of indents 231 are defined by an outer circumferential surface of the first light shielding film 23, and surfaces of the indents 231 and an inner circumferential surface of the lens barrel 22 together define the plurality of holes 232.

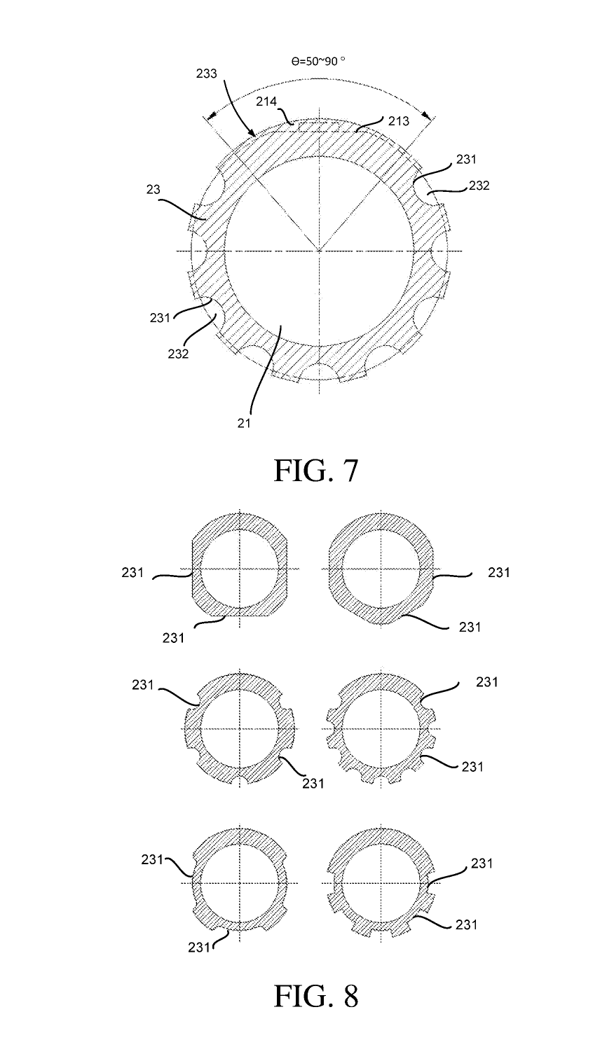

Refer to FIG. 7, which includes a cross-sectional side view and a top view illustrating an intact arc part ranging from 50° to 90° in a lens assembly module for completely covering an opening in accordance with an embodiment of the present disclosure.

In an embodiment of the present disclosure, a depression 213 is defined by a lateral side of the lens 21 closest to the rear end 222, the depression 213 and the peripheral wall 223 of the lens barrel 22 together define an opening 214 (e.g. a slit). As shown in FIG. 7, for ensuring that the first light shielding film 23 completely covers the opening 214 for achieving the waterproof sealing effect, the first light shielding film 23 includes an intact arc part 233 ranging from 50° to 90°, wherein no indent 231 is defined by the intact arc part 233, and the intact arc part 233 is configured for completely covering the opening 214.

Specifically, the depression 213 is defined by a circumferential surface of the lens 21 closest to the rear end 222, a surface of the depression 213 and the inner circumferential surface of the lens barrel 22 together define the opening 214, and the intact arc part 233 ranging from 50° to 90° of the first light shielding film 23 is configured to completely cover the opening 214.

Refer to FIG. 8, which includes top views illustrating various first light shielding films in accordance with multiple embodiments of the present disclosure.

As shown in FIG. 8, in an embodiment of the present disclosure, in addition to at least an intact arc part 233 ranging from 50° to 90° covering the opening 214, the first light shielding film 23 may have various numbers and shapes of the indents 231. Moreover, the lenses 21 in the lens assembly module 2 may also be non-circular lenses. Furthermore, the shape and the size of the first light shielding film 23 may specifically match the shape and the size of the lenses 21, making the lens assembly module 2 be assembled and manufactured easily and reducing stray light.

In an embodiment of the present disclosure, the lens assembly module 2 further includes a second light shielding film 24, wherein the second light shielding film 24 is configured for shielding stray light, is disposed between two of the lenses 21, and is adjacent to circumferences of the two lenses 21 and the peripheral wall 223 of the lens barrel 22, wherein the second light shielding film 24 is annular and coaxial with the lens barrel.

In the lens assembly module in accordance with an embodiment of the present disclosure, the first light shielding film is disposed in the mounting recess defined by the surface of the lens closest to the rear end to replace the back cover for reducing the manufacture costs of the lens assembly module. The indents defined by the outer circumference of the first light shielding film, together with the peripheral wall of the lens barrel, defines a plurality of holes, through which the first light shielding film is bonded to the lens closest to the rear and the lens barrel by an adhesive. A depression defined by the circumference of the lens closest to the rear end is completely covered by the intact arc part of the first light shielding film for achieving the waterproof sealing effect. Material of the first light shielding film includes black polyethylene terephthalate (PE) having a low reflectivity and fulfilling the function of reducing stray light.

The present disclosure has been described with a preferred embodiment thereof and it is understood that various modifications, without departing from the spirit of the present disclosure, are in accordance with the embodiments of the present disclosure. Hence, the embodiments described are intended to cover the modifications within the scope and the spirit of the present disclosure, rather than to limit the present disclosure.

In summary, although the preferable embodiments of the present disclosure have been disclosed above, the embodiments are not intended to limit the present disclosure. A person of ordinary skill in the art, without departing from the spirit and scope of the present disclosure, can make various modifications and variations. Therefore, the scope of the disclosure is defined in the claims.

What is claimed is:

1. A lens assembly module comprising:
a plurality of lenses configured for forming an optical image of an object,
a lens barrel disposed around the lenses for supporting the lenses, and including an incident end, where light from the object enters the lens barrel, and an emergent end, where light from the object exits the lens barrel; and
a first light shielding film configured for shielding stray light, and disposed in a mounting recess, which is defined by a surface of one of the lenses closest to the emergent end and is adjacent to a circumference of the lens closest to the emergent end, wherein the first light shielding film and the mounting recess are both annular.

2. The lens assembly module as claimed in claim 1, wherein a depression is defined by a circumferential surface of the lens closest to the emergent end, a surface of the depression and the inner circumferential surface of the lens barrel together define an opening, and the first light shielding film is configured to completely cover the opening.

3. The lens assembly module as claimed in claim 2, wherein a plurality of indents are defined by an outer circumferential surface of the first light shielding film, and surfaces of the indents and an inner circumferential surface of the lens barrel together define a plurality of holes.

4. The lens assembly module as claimed in claim 3, wherein the first light shielding film includes an intact arc part ranging from 50° to 90°, wherein no indent is defined by the intact arc part, and the intact arc part is configured for completely covering the opening.

5. The lens assembly module as claimed in claim 3, wherein the first light shielding film is bonded to the lens closest to the emergent end and the lens barrel by an adhesive through the holes.

6. The lens assembly module as claimed in claim 1, wherein an outer radius of the first light shielding film is shorter than or equivalent to a radius of the lens closest to the emergent end.

7. The lens assembly module as claimed in claim 1, wherein material of the first light shielding film includes black polyethylene terephthalate (PE).

8. The lens assembly module as claimed in claim 1, wherein an angle between a side wall and a bottom of the mounting recess ranges from 93° to 130°, and a depth of the mounting recess is deeper than 0.01 mm.

9. The lens assembly module as claimed in claim 5, wherein a sub-recess is defined by a bottom of the mounting recess for storing the adhesive, and is adjacent to the circumference of the lens closest to the emergent end.

10. The lens assembly module as claimed in claim 1, further comprising a second light shielding film configured for shielding stray light, and disposed between two of the lenses, wherein the second light shielding film is annular.

11. A lens assembly module, comprising:
a lens barrel including:
a front end being close to an object side of the lens assembly module;
a rear end being close to an image side of the lens assembly module and being opposite to the front end; and
a peripheral wall which extends along an axis from the front end to the rear end and surrounds the axis to define a receiving chamber;
a plurality of lenses disposed in the receiving chamber in sequence along the axis between the front end and the rear end of the lens barrel, wherein an annular mounting recess is defined by a surface of one of the lenses closest to the rear end and is adjacent to the peripheral wall of the lens barrel, and
a first light shielding film disposed in the mounting recess, wherein the first light shielding film and the mounting recess are both annular and coaxial with and the lens barrel.

12. The lens assembly module as claimed in claim 11, wherein a depression is defined by a lateral side of the lens closest to the emergent end, the depression and the peripheral wall of the lens barrel together define an opening, and the first light shielding film is configured to completely cover the opening.

13. The lens assembly module as claimed in claim 12, wherein a plurality of indents are defined by a lateral side of the first light shielding film, and the indents and the peripheral wall of the lens barrel together define a plurality of holes.

14. The lens assembly module as claimed in claim 13, wherein the first light shielding film includes an intact arc part ranging from 50° to 90°, wherein no indent is defined by the intact arc part, and the intact arc part is configured for completely covering the opening.

15. The lens assembly module as claimed in claim 13, wherein the first light shielding film is bonded to the lens closest to the rear and the lens barrel by an adhesive through the holes.

16. The lens assembly module as claimed in claim 11, wherein an outer radius of the first light shielding film is shorter than or equivalent to a radius of the lens closest to the rear end.

17. The lens assembly module as claimed in claim 11, wherein material of the first light shielding film includes black polyethylene terephthalate (PE).

18. The lens assembly module as claimed in claim 11, wherein an angle between a side wall and a bottom of the mounting recess ranges from 93° to 130°, and a depth of the mounting recess is deeper than 0.01 mm.

19. The lens assembly module as claimed in claim 15, wherein a sub-recess is defined by a bottom of the mounting recess for storing the adhesive, and is adjacent to the peripheral wall of the lens barrel.

20. The lens assembly module as claimed in claim 11, further comprising a second light shielding film configured for shielding stray light, and disposed between two of the lenses, wherein the second light shielding film is annular and coaxial with the lens barrel.
